(19) United States
(12) Patent Application Publication
(10) Pub. No.: US 2009/0193435 A1
(43) Pub. Date: Jul. 30, 2009

(54) CONVERTER FOR CONVERTING COMMUNICATION METHOD AND/OR COMMUNICATION PROTOCOL

(76) Inventor: Masahide YAMAKI, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/020,641

(22) Filed: Jan. 28, 2008

(51) Int. Cl. G06F 13/00

(52) U.S. Cl. 719/315

(57) ABSTRACT

A communication converter for converting a communication method and/or a communication protocol in order to enable communication between a medical device and a medical support control device for controlling the medical device, comprising: a storage unit for storing a command list for the medical device; an obtainment unit for obtaining data transmitted from the medical device; a message creation unit for determining whether or not each command included in the data is registered in the command list, and for creating a first or second message on the basis of a result of the determination; and an output unit for outputting the first or second message to the medical support control device.

### BACKGROUND OF THE INVENTION

1. Field of the Invention

The present invention relates to a communication converter used for connecting a plurality of medical devices and a medical support control system that controls these medical devices.

2. Description of the Related Art

In recent years, surgical operations have been performed using endoscopic operation systems having a plurality of medical devices. When body tissues are to be cut by using an insufflation device for inflating abdominal cavities or by using a device for treating affected areas, or when blood stanching is performed by using the high-frequency cautery device in the endoscopic surgical operations, the operating persons perform these procedures while viewing images obtained by endoscopes.

The endoscopic surgical operation system has a plurality of medical devices to be used for the endoscopic operations, a system controller used for controlling these medical devices, a display manipulation device, and the like. Because the endoscopic surgical operation system consists of a plurality of devices, it is necessary to have a common communication protocol in order to enable communications among the devices. However, the communication methods and/or the communication protocols employed by the medical devices vary depending upon the manufacturers of the devices. In order to cope with this variation, communication converters are used in order to enable the communications by performing interconversion of the communication methods and/or the communication protocols employed by the medical devices.

The “communication methods” used herein are communication methods based on a physical or electrical configuration structured for communications, such as infrared communications, USB (Universal Serial Bus) communications, RS-232C communications, Controller Area Network (CAN) communications, Ethernet, or the like. The “variation of communication methods” used herein are the variations in the standards either in the physical or electrical aspect, such as the difference between the wireless communications and the wired communications or the differences among connecter configurations in these various communication methods (the differences due to which, physical or logical connections are impossible). Also, the phrase “communication protocols” used herein is used in its normal meaning, and refers to the logical connections, whereas the above “communication methods” refers to the physical or electrical connections.

### SUMMARY OF THE INVENTION

A communication converter according to the present invention is a communication converter for converting a communication method and/or a communication protocol in order to enable communications between a medical device and a medical support control device for controlling the medical device, comprising:

a storage unit for storing a command list for the medical device;

an obtainment unit for obtaining data transmitted from the medical device;

a message creation unit for determining whether or not each command included in the data is registered in the command list, and for creating a first or second message on the basis of a result of the determination; and

an output unit for outputting the first or second message to the medical support control device.

A medical support control system according to the present invention is a medical support control system, comprising:

a medical device;

a medical support control device for controlling the medical device; and

a communication converter for holding a command list for the medical device, and for converting a communication method and/or a communication protocol in order to enable communications between the medical device and the medical support control device, wherein:

the communication converter obtains data transmitted from the medical device, determines whether or not each command included in the data is registered in the command list, and outputs a first or second message to the medical support control device on the basis of a result of the determination.

### BRIEF DESCRIPTION OF THE DRAWINGS

FIG. 1 shows an entire configuration of an endoscopic operation system according to the present embodiment;

FIG. 2 shows a wiring diagram of the system between a system controller 114 and medical devices that constitute an endoscopic operation system 1;

FIG. 3 shows connections between a host computer and medical devices that employ communication methods or communication protocols different from those employed in the host computer;

FIG. 4 is an example of a perspective view of a casing of a communication converter 201 in the present embodiment;

FIG. 5 is an example of a bottom view of the casing of the communication converter 201 in the present embodiment;

FIG. 6 shows the outline of an internal configuration of the communication converter 201 in the present embodiment;

FIG. 7 shows the communication converter 201 being affected by high voltages or high frequency waves generated in the medical devices;

FIG. 8 shows noise caused in data transmitted from medical devices 302 to the communication converters 201 under the influence of high voltages or high frequency waves generated in the medical devices 302;

FIG. 9 shows an example of a list of commands stored in a data table 406 in the present embodiment; and

FIG. 10 is a flowchart for the communication converters 201 in the present embodiment.

### DESCRIPTION OF THE PREFERRED EMBODIMENTS

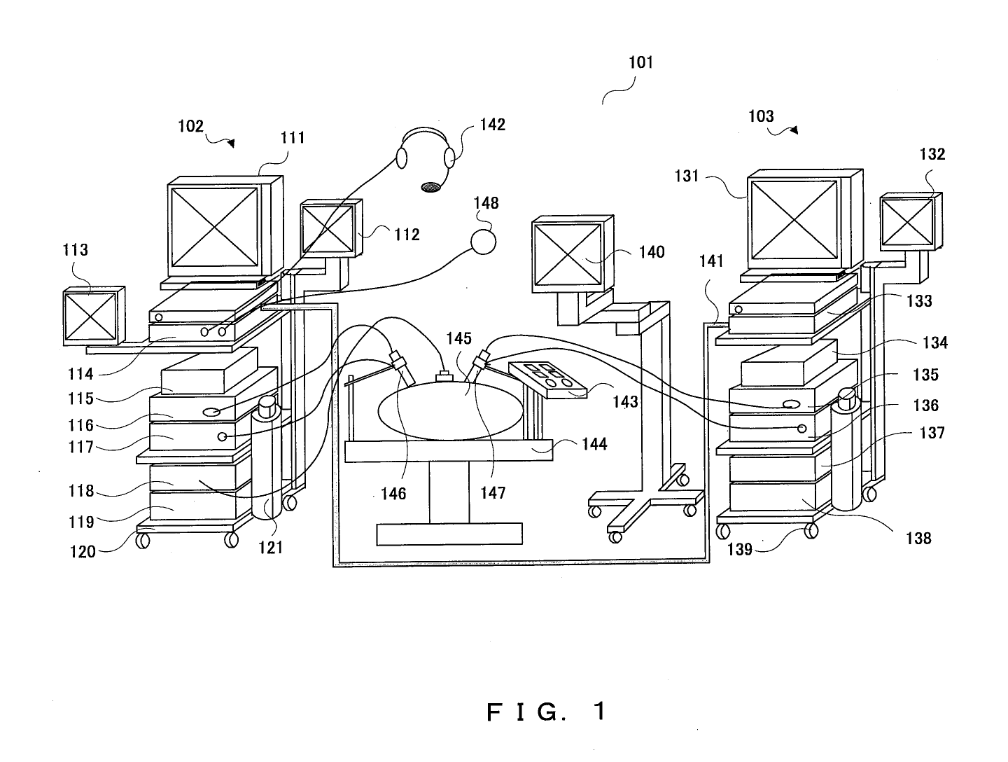

FIG. 1 shows an entire configuration of an endoscopic operation system according to the present embodiment. In an endoscopic operation system 1, a first endoscopic operation system 102 and a second endoscopic operation system 103 beside a bed 144 on which a patient 145 is laid and a wireless remote controller 143 for the operating person are provided.

The endoscopic operation systems 102 and 103 respectively have first and second trolleys 120 and 139 each including a plurality of endoscope peripheral devices used for observation, examination, procedures, recoding, and the like. Also, an endoscope image display panel 140 is arranged on a movable stand.

On the first trolley 120, an endoscope image display panel 111, a central display panel 112, a central manipulation panel device 113, a system controller 114, a recorder 115, a video processor 116, an endoscope light source device 117, an insufflation unit 118, and an electrical surgical device 119 are arranged.

The central manipulation panel device 113 is arranged in a non-sterilization area to be used by nurses or the like in order to manipulate the respective medical devices in a centralized manner. This central manipulation panel device 113 may include a pointing device such as a mouse, a touch panel, or the like (not shown). By using the central manipulation panel device 113, the medical devices can be managed, controlled, and manipulated in a centralized manner.

The respective medical devices are connected to the system controller 114 via communication cables (not shown) such as serial interface cables or the like, and can have communications with one another.

Also, a headset-type microphone 142 can be connected to the system controller 114. The system controller 114 can recognize voices input through the headset-type microphone 142, and can control the respective devices in accordance with the voices of the operating person.

The endoscope light source device 117 is connected to a first endoscope 146 through a light-guide cable used for transmitting the illumination light. The illumination light emitted from the endoscope light source device 117 is provided to the light guide of the first endoscope 146 and illuminates the affected areas or the like in the abdomen of the patient 145 into which the insertion unit of the first endoscope 146 has been inserted.

The optical image data obtained through the camera head of the first endoscope 146 is transmitted to a video processor 116 through a camera cable. The optical image data undergoes signal processing in a signal processing circuit in the video processor 116, and the video signals are created.

The insufflation unit 118 provides CO₂ gas to the abdomen of the patient 145 through a tube. The CO₂ gas is obtained from a gas tank 121.

On the second trolley 139, an endoscope image display panel 131, a central display panel 132, a expansion unit 133, a recorder 134, a video processor 135, an endoscope light source device 136, and other medical devices 137 and 138 (such as an ultrasonic processing device, a lithotripsy device, a pump, a shaver, and the like) are arranged. These respective devices are connected to the expansion unit 133 through cables (not shown), and can communicate with one another. The system controller 114 and the expansion unit 133 are connected to each other through the expansion cable 141.

The endoscope light source device 136 is connected to a second endoscope 147 through the light-guide cable for transmitting the illumination light. The illumination light emitted from the endoscope light source device 136 is provided to the light guide of the second endoscope 147, and illuminates the affected areas or the like in the abdomen of the patient 145 into which the insertion unit of the second endoscope 147 has been inserted.

The optical image data obtained through the camera head of the second endoscope 147 is transmitted to a video processor 135 through a camera cable. The optical image data undergoes signal processing in a signal processing circuit in the video processor 135, and the video signals are created. Then, the video signals are output to the endoscope image display panel 131, and endoscope images of the affected areas or the like are displayed on the endoscope image display panel 131

Further, the system controller 114 can be controlled by the operating person manipulating the devices in the non-sterilization area by using a remote controller 143. Also, the first and second trolleys 120 and 139 can include other devices such as printers, ultrasonic observation devices, or the like.

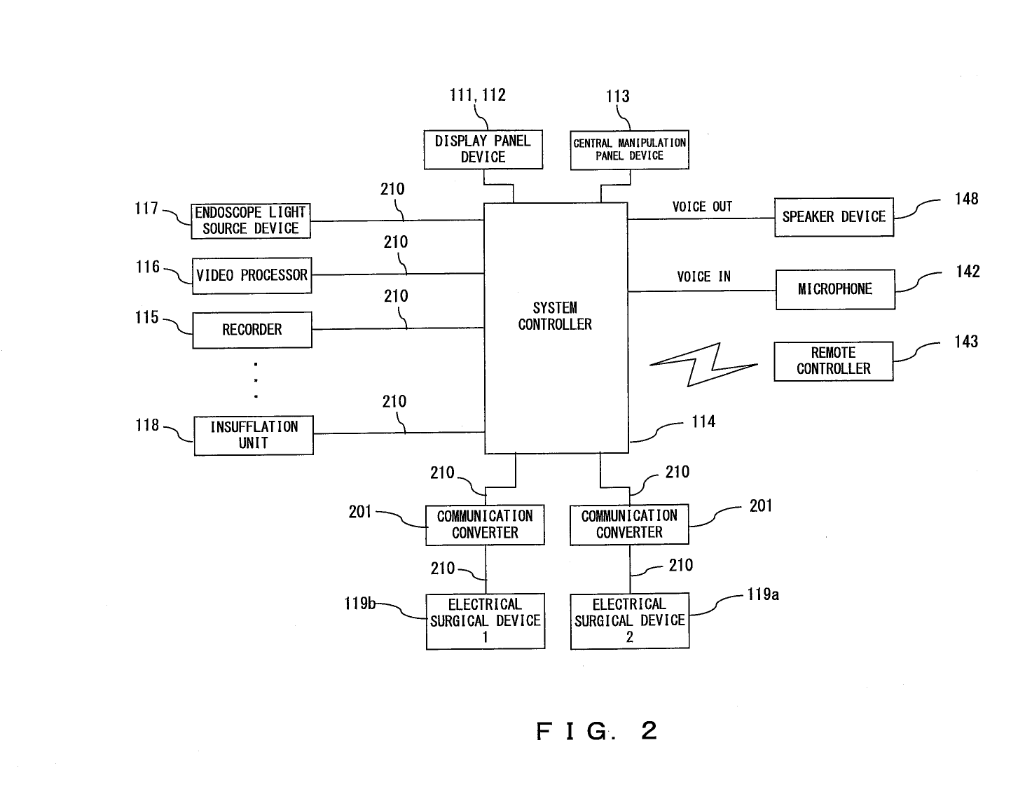

FIG. 2 shows a wiring diagram of the system between the system controller 114 and the medical devices that constitute an endoscopic operation system 1. As shown in FIG. 2, the central display panels 111 and 112 and the central manipulation panel device 113 are connected to the system controller 114. Also, the headset-type microphone 142 for inputting voices and a speaker device 148 for outputting voices are connected to the system controller 114. Also, medical devices such as the endoscope light source device 117, the video processor 116, the recorder 115, the insufflation unit 118, the electrical surgical devices 119a and 119b, and the like are connected to the system controller 114 via wired or wireless communication paths 210.

When the medical devices use communication methods or communication protocols different from that of the system controller 114, the system controller 114 uses the communication converters 201 for the connection. In FIG. 2, the electrical surgical devices 1 and 2 (119a and 119b) are connected to the system controller 114 via the communication converters 201.

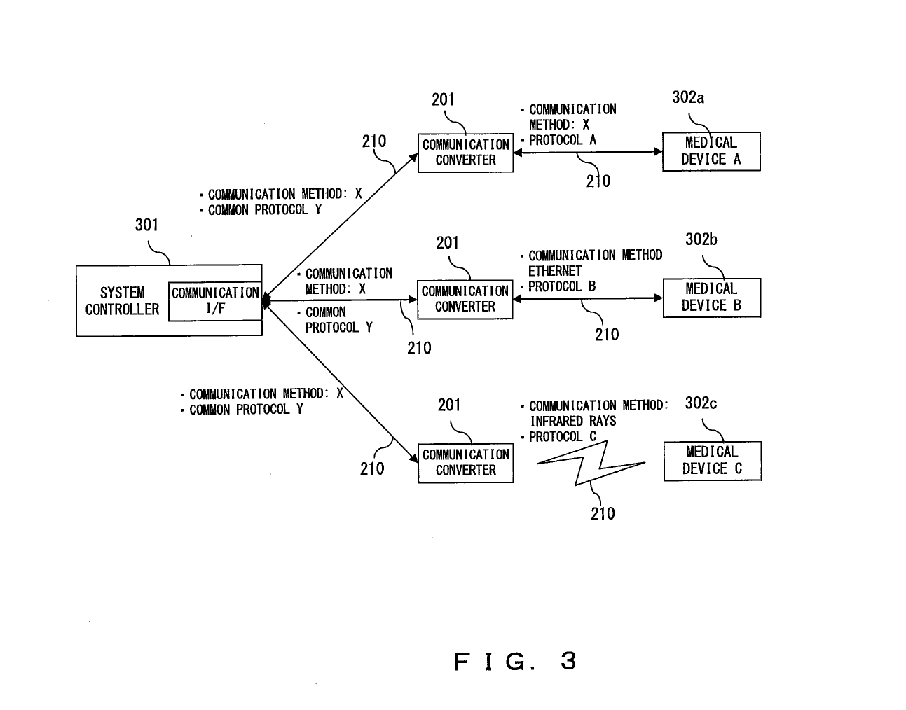

FIG. 3 shows the communication converters for performing interconversion of the communication methods and/or the communication protocols between the host computer and the medical devices in the present embodiment. By referring to FIG. 3, the connection between the host computer and the medical devices respectively employing the different communication methods or communication protocols is explained. A host computer (hereinafter, referred to as the host) 301 corresponds to the system controller 114. In FIG. 3, an example is shown in which the host 301 and the medical device 302 (302a through 302c) are connected by using the communication converters 201 corresponding to the communication methods and communication protocols of the respective medical devices 302.

The communication converters 201 connect the host 301 and the medical devices 302, and perform interconversion of the communication methods and/or the communication protocols in order to enable the communications between the host 301 and the medical devices 302.

Between the communication converters 201 and the host 301, a prescribed communication method and a prescribed communication protocol that are commonly used inside the host 301 side are employed. Also, between the communication converters 201 and the medical devices, prescribed communication methods and prescribed communication protocols that correspond to the communication interfaces (I/F) of the respective medical devices 302a through 302c are employed.

In FIG. 3, the host 301 uses “communication method: X” (for example, RS-232C), and a prescribed communication protocol (hereinafter, referred to as a common protocol) Y as its communication I/F in order to enable the connection and the communication.

Medical device A (302a) uses, for example, “communication method: X” (for example, RS-232C) and communication protocol A as its communication I/F. In this case, the communication protocols are different from each other between the host 301 and medical device A (302a). Accordingly, the host 301 and medical device A (302a) are connected via the communication converter 201 for performing interconversion of the communication protocols.

Also, medical device B (302b) uses, for example, “communication method: Ethernet” and communication protocol B as its communication I/F. In this case, the communication methods and the communication protocols are different from each other between the host 301 and medical device B (302b). Accordingly, the host 301 and medical device B (302b) are connected via the communication converter 201 for performing interconversion of the communication methods and the communication protocols.

Also, medical device C (320c) uses, for example, “communication method: infrared communication” and uses communication protocol C as its communication I/F. In this case, the communication methods and the communication protocols are different between medical device C (302c) and the host 301. Accordingly, the host 301 and medical device C (302c) are connected via the communication converter 201 for performing interconversion of the communication methods and the communication protocols.

As described above, the communication converters 201 can perform interconversion of the communication methods and the communication protocols between the host 301 and the medical devices 302. In order to realize this interconversion, the communication converters 201 are provided with communication I/Fs corresponding to the communication I/Fs of the respective medical devices 302a through 302c, and with communication programs for the communication protocols corresponding to the communication protocols used in the respective medical devices 302a through 302c.

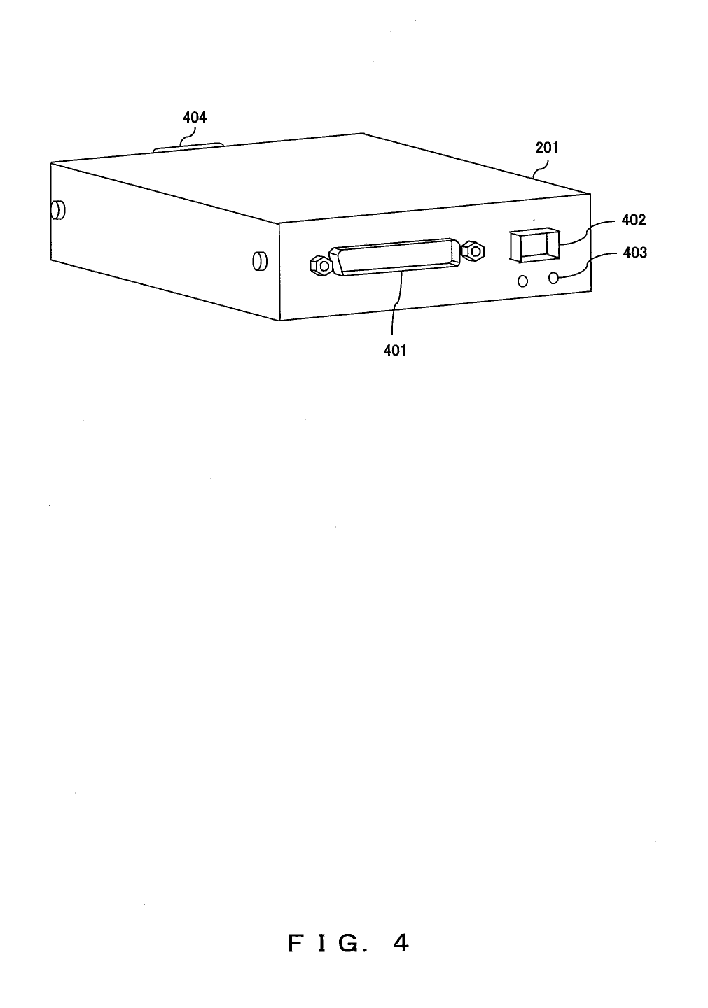

FIG. 4 is an example of a perspective view of a casing of the communication converter 201 in the present embodiment. The communication converter 201 is provided with communication I/Fs that correspond to a plurality of different communication methods and communication protocols (such as the infrared communication I/F, the Ethernet communication I/F, the serial communication I/F, or the like) in order to enable connections with medical devices respectively using various communication methods and various communication protocols.

In FIG. 4, as an example, a serial I/F 401, a CAN I/F 402, and an infrared communication I/F 403 are provided on the front panel. Also, on the back panel, a communication I/F 404 that corresponds to the communication I/F for the host 301 (i.e., the system controller 114) is provided. Also, the communication interface provided in the communication converters 201 are not limited to these types, and can be of any type of known interface.

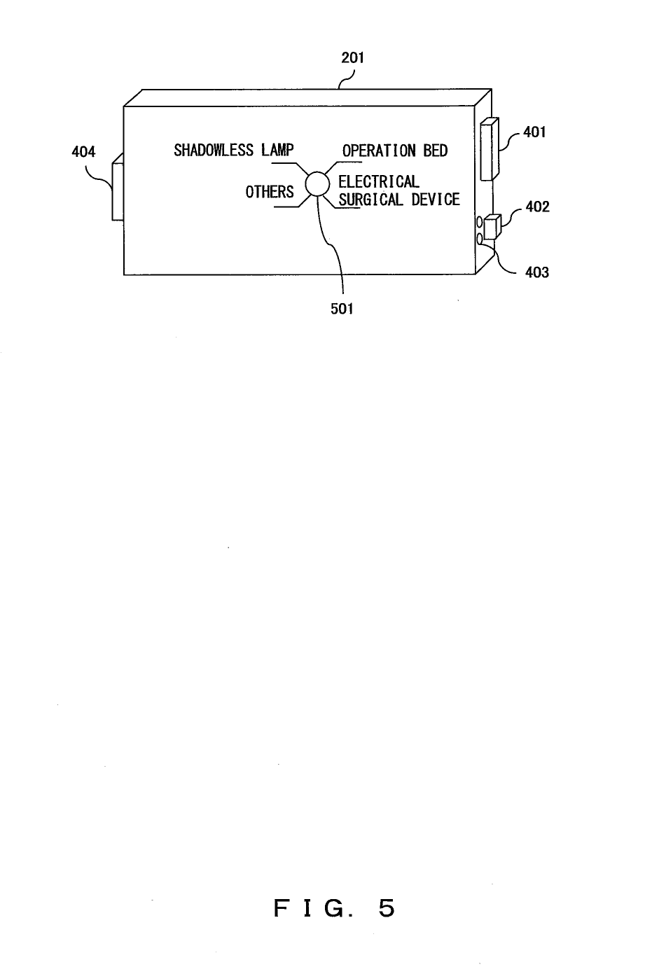

FIG. 5 is an example of a bottom view of the casing of the communication converter 201 in the present embodiment. On the bottom surface of the communication converter 201, a selection switch 501 used for selecting a medical device as a connection target is provided. In FIG. 5, a rotary switch is used as the selection switch 501. By using this selection switch 501, categories of medical devices as connection targets such as “operation bed”, “electrical surgical device”, “shadowless lamp”, and “others” can be selected. The communication converter 201 downloads thereto the communication program corresponding to the communication protocol for the medical device of the selected category. For example, when “electrical surgical device” is selected by using the selection switch 501, the communication converter 201 downloads, from the host 301, the communication program for the communication protocol for the medical device “electrical surgical device” in advance.

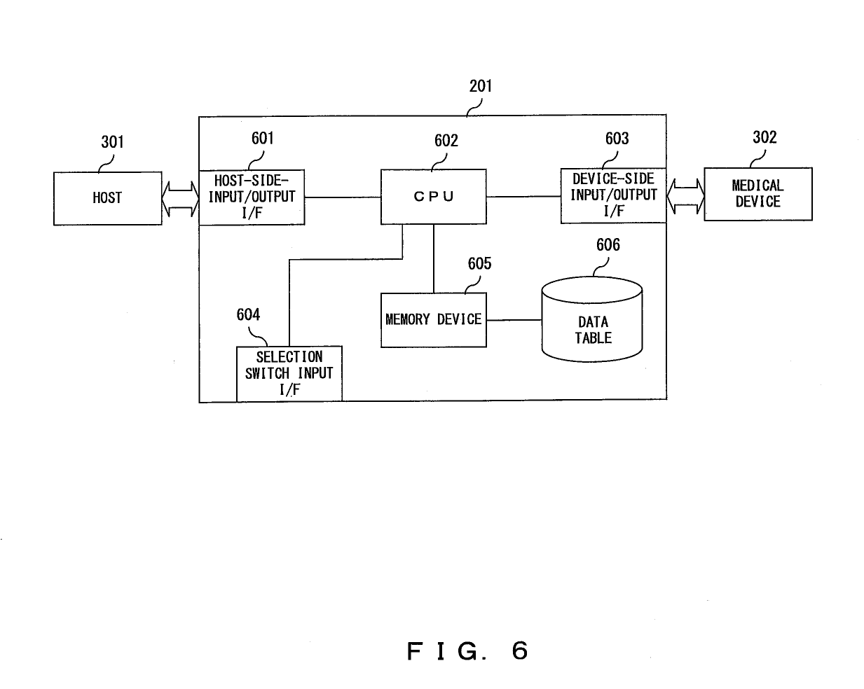

FIG. 6 shows the outline of an internal configuration of the communication converter in the present embodiment. In the communication converter 201, a host-side-input/output I/F 601, a CPU 602, a device-side input/output I/F 603, a selection switch input interface 604, and a memory device 605 are provided.

The host-side-input/output I/F 601 is a communication interface corresponding to the communication I/F for the host 301 (system controller 114), through which data is output to the host 301 and is input from the host 301. The host-side-input/output I/F 601 corresponds to the communication I/F 401 shown in FIGS. 4 and 5.

The memory device 605 stores the programs in the present embodiment, the communication program downloaded from the host 301, and other programs. Also, the memory device 605 has a data table 606 that will be described later. Examples of the memory device 605 are a ROM device, a RAM device, a hard disk drive, a flash memory device, and the like. The memory 605 is included in the communication converter 201 in the present embodiment; however, the scope of the present invention is not limited to this configuration, and the memory device can be of an external type (including transportable storage media such as a USB memory device, an SD memory card, or the like).

The CPU 602 is a central processing device that controls the operations of the respective elements of the communication converter 201 and reads and executes the programs or the like stored in the memory device 605.

The device-side input/output I/F 603 is a communication I/O corresponding to the communication I/F for device such as the medical device 302 or the like, through which data is output to the medical device 302 and is input from the medical device 302. The device-side input/output I/F 603 corresponds to the serial I/F 401, the CAN I/F 402, or the infrared communication I/F 403 shown in FIGS. 4 and 5.

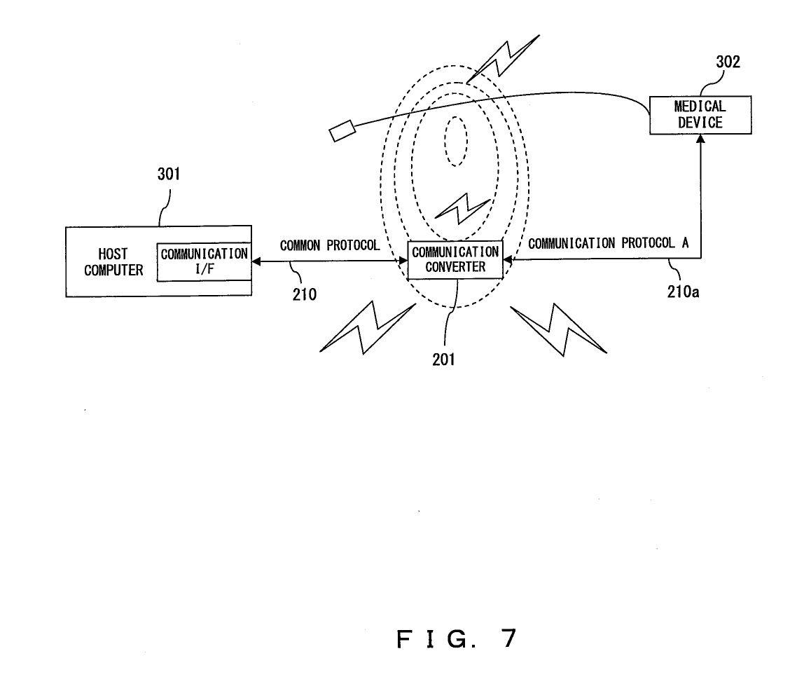

FIG. 7 shows the communication converter 201 being affected by the high voltages or the high-frequency waves generated in the medical devices. In FIG. 7, the common protocol is used between the host 301 and the communication converter 201, and protocol A is used between the medical device 302 and the communication converter 201.

When a medical device 302 such as the electrical surgical device or the like is operated in this configuration, a high voltage or a high-frequency wave is generated temporarily. As a result of this, the communication converter 201 located around the medical device 302 and/or the communication path 210a connecting the medical device 302 and the communication converter 201 are apt to be affected by the high voltage or high-frequency wave. Accordingly, noise often occurs in the data signals conveyed through the communication path 210a.

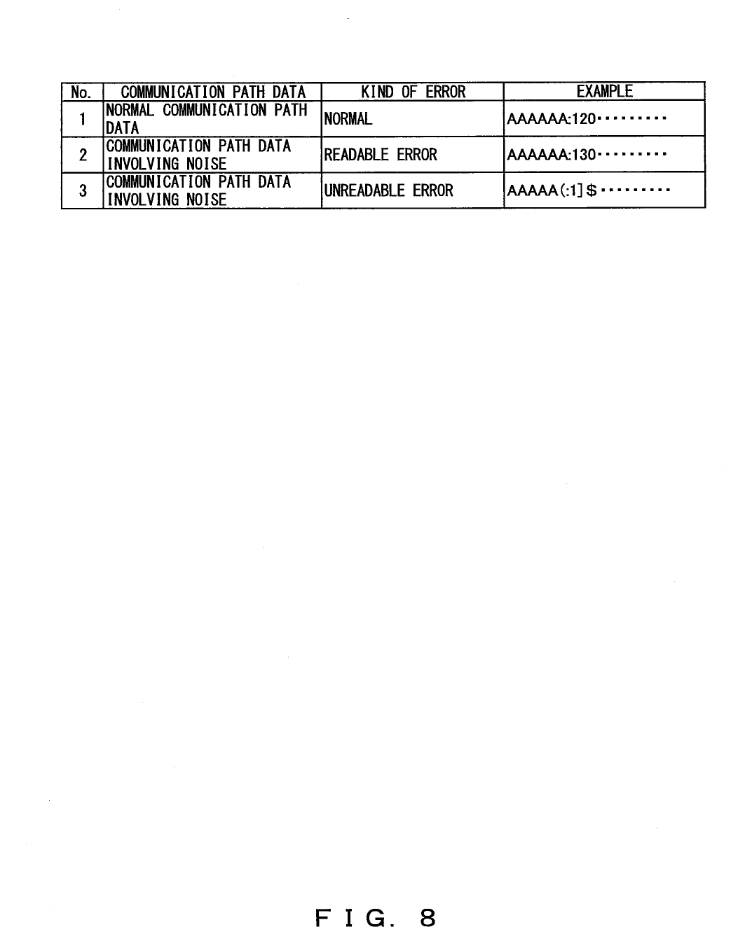

FIG. 8 shows noise caused in data transmitted from the medical devices 302 to the communication converters 201 under the influence of high voltages or high-frequency waves generated in the medical devices 302. As an example, the data (communication path data) transmitted from the medical devices 302 to the communication converters 201 is expressed in the form of text data consisting of a plurality of commands for changing the statuses that indicates the fact that the output value of the medical device 302 is incremented by a prescribed value or the output mode is changed into an arbitrary mode.

As an example, normal communication path data is expressed as “AAAAAA:120”. “AAAAAA:120” is, for example, a command for changing a set value of a status indicating the fact that the output value of a prescribed function of the medical device 302 has been changed.

When the communication converter 201 and/or the communication path 210a is affected by the high voltage or the high-frequency wave, noise is caused on the communication path, which causes a risk that a readable error or an unreadable error will occur.

A “readable error” is an error in which a character string or the like expressing one meaning (such as a numerical value, a character, a command, or the like) is changed into another character string (such as a numerical value, a character, a command, or the like) expressing a different meaning. As shown in FIG. 8, when the readable error has occurred, the original communication path data “AAAAAA:120” is changed into “AAAAAA:130”. In this case, the host 301 can read “AAAAAA:130” as data in spite of the fact that error is involved in the communication path data.

An “unreadable error” is an error in which a character string or the like expressing one meaning (such as a numerical value, a character, a command, or the like) is changed into another character string containing garbled characters so that the character string does not express any meaning.

In FIG. 8, the original communication path data “AAAAAA:120” is changed into “AAAAA(:1]$” due to the garbling of the characters. In this case, the host 301 cannot read “AAAAA(:1]$” as data.

When the communication data is affected, as described above, by the high voltages or the high-frequency waves generated in the medical devices, the host 301 cannot read the normal and the original communication data, and therefore cannot cause the monitors to display correct status information or the like of the medical devices. In order to cope with this problem, in the present embodiment, the communication converters 201 check whether or not noise is involved in the communication path data.

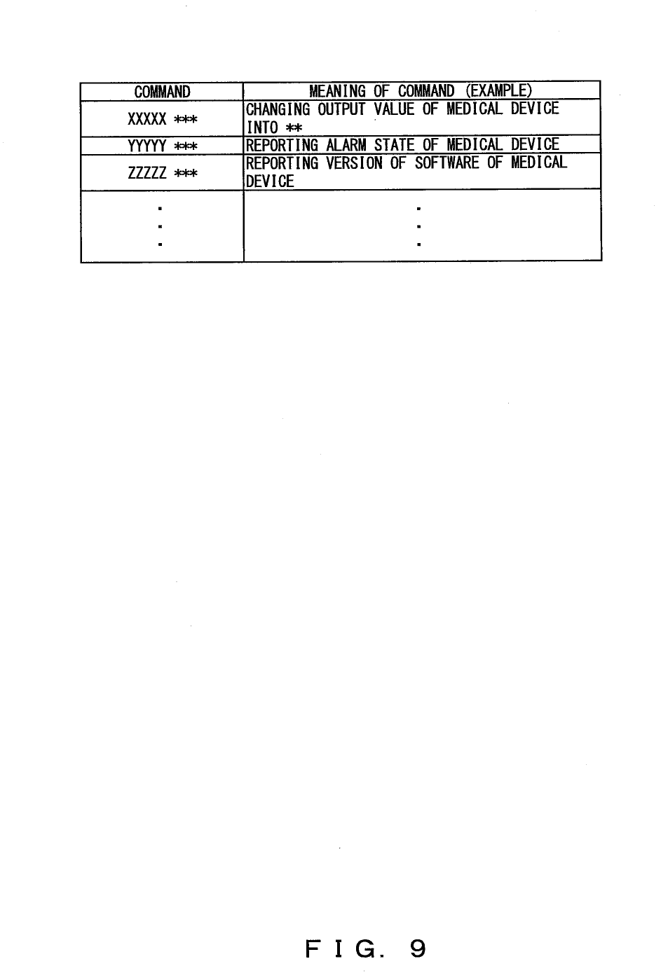

FIG. 9 shows an example of a list of commands stored in the data table 406 in the present embodiment. The data table 406 stores the command list for the medical devices 302 connected to the communication converters 201. The command “XXXXX ***” is a command for changing the output value of the medical devices into a prescribed value ***. The command “YYYYY ***” is a command for reporting the alarm state “***” of the medical devices. The command “ZZZZZ ***” is a command for reporting a version “***” of software of the medical devices.

The commands in the command list may be set in the command table 406 before the communication converters 201 and the medical devices 302 are connected. Alternatively, when the communication converters 201 and the medical devices 302 are connected, the commands may be downloaded from the medical devices 302 to the communication converters 201 in order to be stored in the data table 406. Also, the data table 406 may store not only the command list, but also reserved words used for the communication path data.

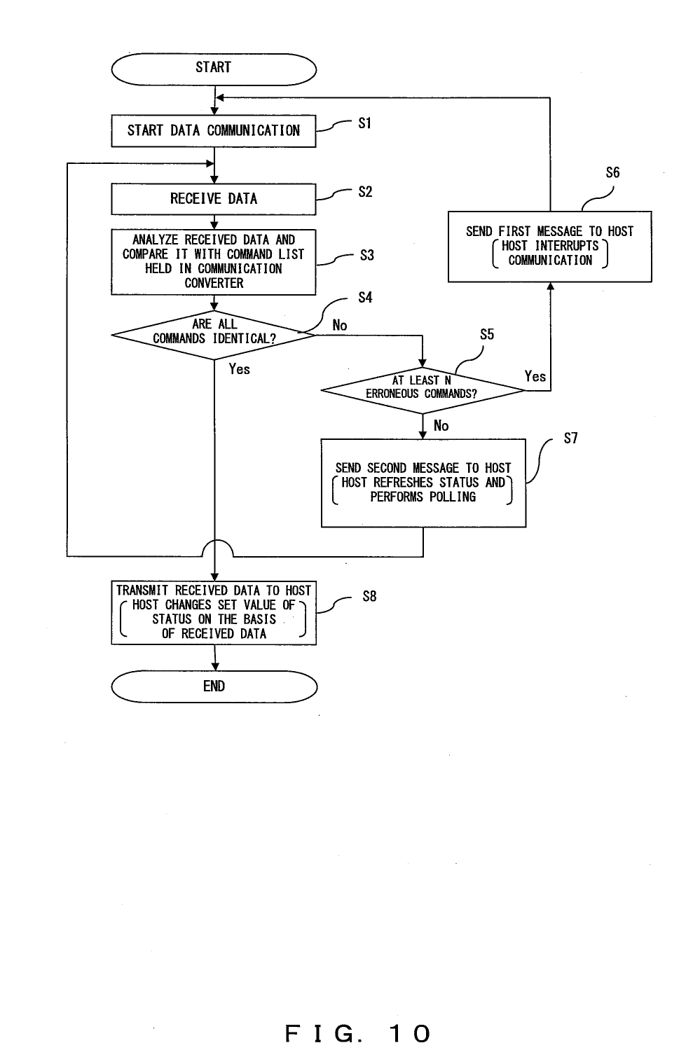

FIG. 10 is a flowchart for the communication converters 201 in the present embodiment. The CPU 602 reads the program in the present invention from the memory device 605, and executes this process flow.

The communication converters 201 establish communications with the host 301, and start communications. Further, the communication converters 201 establish communications with the medical devices 302, and start communications (S1). Then, the host 301 performs the polling to the medical devices 302 via the communication converters 201.

In response to the above polling, each medical device 302 transmits its status information as the communication path data. Then each communication converter 201 receives the communication path data from the medical device 302 (S2).

The communication converter 201 analyzes the received communication path data, and compares the respective commands in the communication path data with the commands in the command list in the data table 406 (S3). Specifically, the communication converter 201 sequentially reads the commands in the received communication path data, and performs comparison in order to confirm whether or not the read commands are registered in the data table 406. When the read command is not registered in the data table 406, it is determined that an error (unreadable error) has occurred because the read command contains garbled characters. This comparison process is repeated on all the commands included in the communication path data.

After the comparison process is completed in S3, the communication converter 201 determines whether or not all the commands in the communication path data were identical to the commands in the command list (S4). When there are at least “n” (n≧1) commands that are not identical (errors) in the communication data (No in S4 and Yes in S5), the communication converter 201 creates a first message and transmits it to the host 301 (S6). The host 301, when receiving this first message, interrupts the communication with the communication converters 201, and again establishes the communication. Then, the communication converter 201 repeats the processes in and after S1.

Also, when there are less than “n” commands that are not identical (errors) (No in S5), the communication converter 201 creates a second message indicating that noise is involved in the communication path data, and transmits it to the host 301 (S7). The host 301, when receiving this second message, refreshes the value of the status displayed in the monitor device. At the same time, the host 301 performs the polling again.

In response to this polling, each medical device 302 transmits its status information as the communication path data. Each communication converter 201 receives the communication path data from the medical device 302 (S2), and performs the comparison in S3. The communication converter 201 repeats the processes in S1 through S7 until it is confirmed that there are no more error commands in the received communication path data.

When all the commands included in the communication path data are identical to the commands in the command list (Yes in S4), the communication converter 201 converts into the common protocol the communication protocol in the received communication path data, and transmits the communication path data to the host 301 (S8). The host 301, when receiving the communication path data, reads the set value of the status in the communication path data, and updates the status information displayed in the monitor device.

Also, the first message can be a message that prompts the host 301 to interrupt the communication, and also may be a message that reports the fact that there are “n” erroneous commands in the communication path data. Also, the second message can be a message that prompts the host 301 to perform polling, and also may be a message that reports the fact that there are “n” erroneous commands in the communication path data. It is also possible to employ a configuration in which the host 301 determines whether to perform the refresh/polling of the status or to interrupt the communication (S5 in FIG. 10) if the configuration of transmitting the message reporting the fact that there are “n” erroneous commands in the communication path data to the host 301 is employed.

Also, the host 301 can cause the monitor device to display, as an error log, the first and second messages received. Thereby, users can understand the communication status between the medical devices 302 and the communication converters 201.

As described above, according to this process flow, it is possible to detect unreadable errors involved in communication path data, to perform reconnection on the basis of the number of errors, and to refresh the status displayed in a monitor device.

Also, it is possible to perform reconnection or to perform polling again. In the case of the reconnection, polling is to be performed after the establishment of communications, which requires a longer time before the obtainment of communication path data than in the case of performing only polling. Accordingly, in the present embodiment, the frequency of the reconnection can be adjusted by changing the threshold value on the basis of the number of detected errors, and therefore, the time loss in communications can be reduced.

What is claimed is:

1. A communication converter for converting a communication method and/or a communication protocol in order to enable communications between a medical device and a medical support control device for controlling the medical device, comprising:
a storage unit for storing a command list for the medical device;
an obtainment unit for obtaining data transmitted from the medical device;
a message creation unit for determining whether or not each command included in the data is registered in the command list, and for creating a first or second message on the basis of a result of the determination; and
an output unit for outputting the first or second message to the medical support control device.

2. The communication converter according to claim 1, wherein:
the message creation unit creates a message as the first message, said message requesting the medical support control device to perform reconnection of communications with the medical device when it is determined that at least n (n≧1) commands in the data are not registered in the command list.

3. The communication converter according to claim 1, wherein:
the message creation unit creates a message as the second message, said message prompting the medical support control device to refresh status information of the medical device displayed on a display device when it is determined that less than n (n≧1) commands are not registered in the command list.

4. A medical support control system, comprising:
a medical device;
a medical support control device for controlling the medical device; and
a communication converter for holding a command list for the medical device, and for converting a communication method and/or a communication protocol in order to enable communication between the medical device and the medical support control device, wherein:
the communication converter obtains data transmitted from the medical device, determines whether or not each command included in the data is registered in the command list, and outputs a first or second message to the medical support control device on the basis of a result of the determination.

5. The medical support control system according to claim 4, wherein:
the communication converter outputs the first message when it is determined that at least n (n≧1) commands in the data are not registered in the command list; and
the medical support control device performs reconnection of communication with the medical device when obtaining the first message.

6. The medical support control system according to claim 4, wherein:
the communication converter outputs the second message when it is determined that less than n (n≧1) commands in the data are not registered in the command list; and
the medical support control device refreshes status of the medical device displayed on the display device when obtaining the second message, and requests the medical device to transmit prescribed data of the medical device.

7. The medical support control system according to claim 4, wherein:
when receiving the message, the medical support control device displays content of the message.
